(19) United States
(12) Patent Application Publication
(10) Pub. No.: US 2018/0088757 A1
(43) Pub. Date: Mar. 29, 2018

(54) INFORMATION PROCESSING DEVICE AND INFORMATION PROCESSING METHOD

(71) Applicant: YAMAHA CORPORATION, Hamamatsu-shi (JP)

(72) Inventors: Akihiko Suyama, Hamamatsu-shi (JP); Keisuke Tsukada, Hamamatsu-shi (JP); Kazuya Mushikabe, Hamamatsu-shi (JP)

(21) Appl. No.: 15/830,609

(22) Filed: Dec. 4, 2017

Related U.S. Application Data
(63) Continuation of application No. PCT/JP2016/068837, filed on Jun. 24, 2016.

(51) Int. Cl. G06F 3/0482; G06F 3/0488

(52) U.S. Cl. CPC G06F 3/0482; H04N 21/4222; G06F 3/0488

(57) ABSTRACT

An information processing device, which can be a smartphone, and method can obtain input information and display switching information for switching to a screen of a program based on the obtained input information.

### CROSS REFERENCE TO RELATED APPLICATIONS

The present application is a continuation of International Application No. PCT/JP2016/068837, filed 24 Jun. 2016, the entire contents of which are incorporated herein by reference.

### BACKGROUND OF THE INVENTION

### 1. Field of the Invention

The present invention relates to an information processing device/method that obtains predetermined information and performs various kinds of processing according to the obtained information.

### 2. Description of the Related Art

As disclosed in National Publication of International Patent Application No. 2010-510757, an information processing device, such as a mobile phone, can include a variety of application programs.

In recent years, the application programs of an information processing device have been able to obtain predetermined information from other devices or control other devices. For example, an application program that controls an AV (Audio Visual) receiver is able to receive an operation of selecting an input interface to use, from among a plurality of input interfaces in the AV receiver, and send information that controls the switching of input to the AV receiver.

A device including a large number of input interfaces, such as an AV receiver, can connect to a plurality of devices. The plurality of devices each use a different program in many cases. In such a case, a user needs to not only select an input interface but also additionally search a program related to each of the plurality of devices and start the program.

For example, even when a user selects a BD (Blue-ray Disc) player and switches to the play screen of the BD player, to use a control program for performing detailed control of the BD player, the user has to additionally search and start the control program.

### SUMMARY OF THE INVENTION

Some aspects of the present invention include an information processing device and an information processing method, that can do away with a user requiring to search a program relating to each device.

The information processing device includes a display circuit or device, at least one memory storing instructions, and at least one processor configured to implement the stored instructions and execute a plurality of tasks, including an information obtaining task and a display control task. The information obtaining task obtains input information. The display control task, based on the obtained input information, controls the display device to display switching information for switching to the screen of the program.

The information processing device further includes an input device having an input interface with a plurality of inputs. The information obtaining task obtains input information indicative of each device connected to the input device. The display control task controls the display device to display switching information for switching to the screen of the program associated with each of the plurality of inputs, based on the obtained input information.

The method can provide the corresponding steps.

The present features can save labor of a user required to search a program related to each device.

The above and other elements, features, characteristics, and advantages of the present invention will become more apparent from the following detailed description of the preferred embodiments with reference to the attached drawings.

### BRIEF DESCRIPTION OF THE DRAWINGS

FIG. 1 is a diagram illustrating an overview of an AV system.

FIG. 2 is a diagram illustrating a connection relationship of each device in the AV system.

FIG. 3 is a block diagram illustrating a main configuration of an AV receiver of the AV system.

FIG. 4 is a block diagram illustrating a main configuration of an STB (Set Top Box).

FIG. 5 is a block diagram illustrating a main configuration of a BD player.

FIG. 6 is a block diagram illustrating a main configuration of an automatic performance piano.

FIG. 7 is a block diagram illustrating a main configuration of a smartphone.

FIG. 8 illustrates an example of a display mode of an Input setting screen.

FIG. 9 is a flowchart of an operation of the smartphone.

FIG. 10A illustrates an example of an Input selection screen and FIG. 10B illustrates an example of a play screen.

FIG. 11A illustrates a modification example of the Input selection screen, and FIG. 11B illustrates a modification example of the play screen.

FIG. 12A is a diagram illustrating a play screen on which a symbol image of a related program is displayed, and FIG. 12B is a diagram illustrating a screen of the related program that has been started.

### DETAILED DESCRIPTION

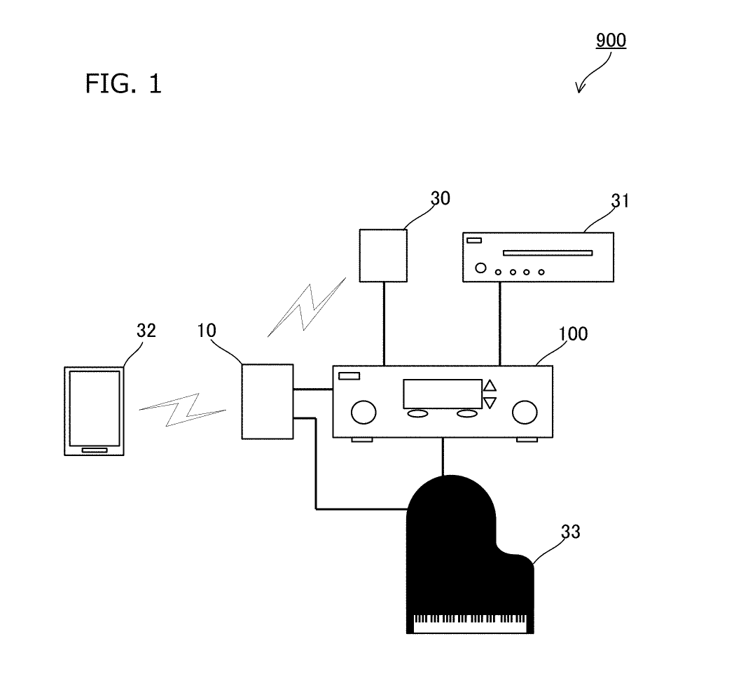

FIG. 1 is a diagram illustrating an overview of an AV system 900. The illustrated AV system 900 is provided with a wireless router 10 as a relay device, an STB 30, a BD player 31, a smartphone 32, an automatic performance piano 33, and an AV receiver 100.

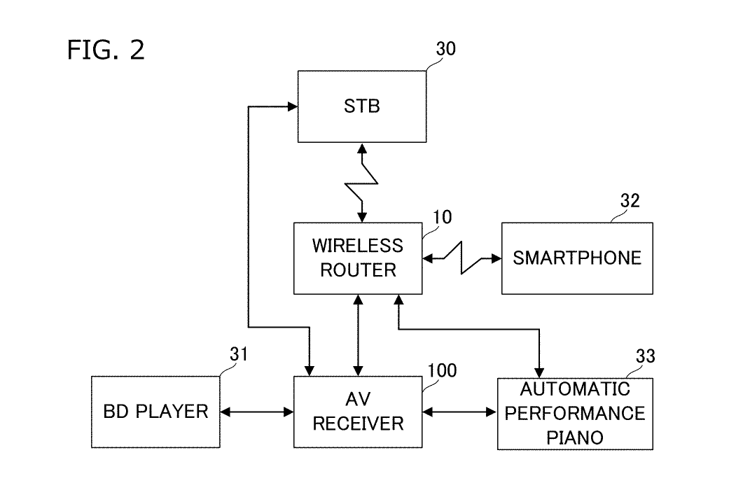

As illustrated in FIG. 2, the STB 30, the smartphone 32, the automatic performance piano 33, and the AV receiver 100 can be connected to one another in a network through the wireless router 10. The wireless router 10 assigns an IP address in the LAN to each of the STB 30, the smartphone 32, the automatic performance piano 33, and the AV receiver 100.

The AV receiver 100 is connected to the STB 30, the BD player 31, and the automatic performance piano 33. The AV receiver 100 can be connected to the STB 30 and the BD player 31, for example, through an HDMI (registered trademark) interface. Therefore, the AV receiver 100, the STB 30, and the BD player 31 are able to mutually send and receive the various types of information of the HDMI (registered trademark)-CEC. The automatic performance piano 33 and the AV receiver 100 can be connected to each other, for example, through an analog audio terminal.

The AV receiver 100 is able to collect information of the STB 30 and the BD player 31 that are connected to the AV receiver itself through the HDMI (registered trademark) interface, for example, and send the collected information to the smartphone 32 through the wireless router 10. The smartphone 32 can function as a controller of the AV receiver 100, and controls the AV receiver 100 and other devices, for example, the automatic performance piano 33, the STB 30, and the BD player 31.

The AV receiver 100 inputs an audio signal, for example, from each device. The AV receiver 100 outputs sound based on the audio signal input from each device to a speaker connected to the AV receiver itself. In addition, the AV receiver 100 inputs a video signal, for example, from each device. The AV receiver 100 outputs a video based on the video signal input from each device to a display device connected to the AV receiver itself.

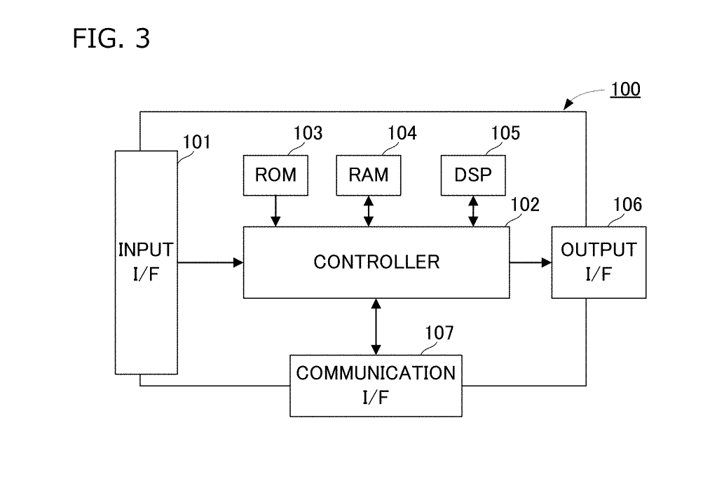

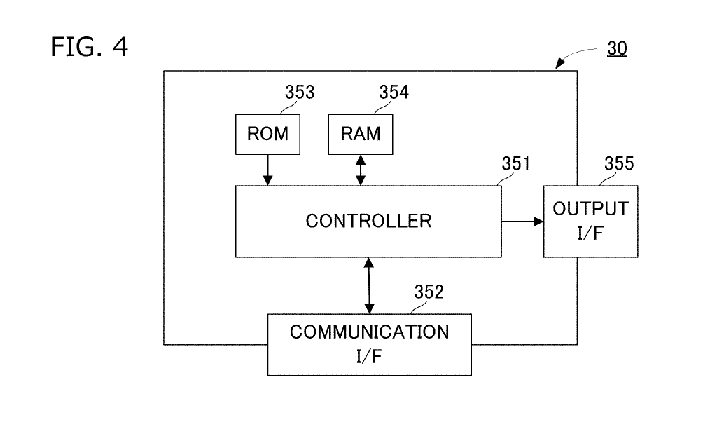

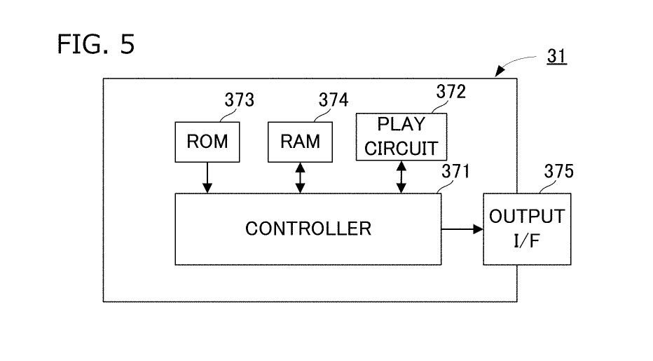

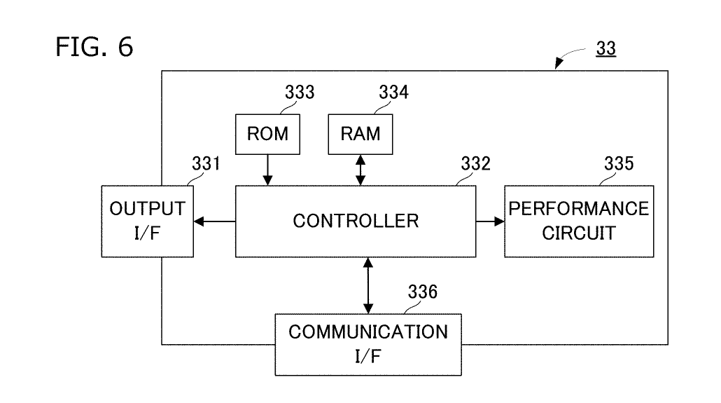

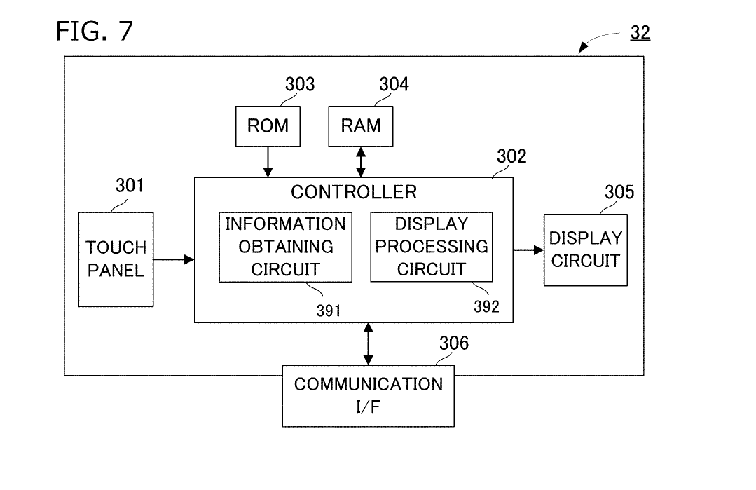

FIG. 3 is a block diagram illustrating a main configuration of the AV receiver 100. FIG. 4 is a block diagram illustrating a main configuration of the STB 30. FIG. 5 is a block diagram illustrating a main configuration of the BD player 31. FIG. 6 is a block diagram illustrating a main configuration of the automatic performance piano 33. FIG. 7 is a block diagram illustrating a main configuration of the smartphone 32.

The AV receiver 100 is provided with an input interface (I/F) 101, a controller 102, which can be a CPU, a ROM 103, a RAM 104, a DSP 105, an output I/F 106, and a communication I/F 107.

The input I/F 101 has a plurality of interfaces, such as an HDMI (registered trademark) terminal, a USB terminal, a digital audio terminal, or an analog audio terminal. In addition, the input I/F 101 also can include a short range network communication interface such as Bluetooth (registered trademark) or NFC. The content data, the audio signal, or the video signal that has been input to the input I/F 101, by control of the controller 102, is input to the DSP 105 and is output to the output I/F 106.

The controller 102, by reading out a program stored in the ROM 103 to the RAM 104 as a work memory and executing the program, controls the various components of the AV receiver 100 in an integrated manner. For example, the controller 102 obtains information of a plurality of devices connected to the input I/F 101 to obtain the current input state of each device. In addition, the controller 102 outputs from the output I/F 106 the audio signal or the video signal according to a device that a user has selected from the plurality of devices connected to the input I/F 101.

The DSP 105 is able to decode audio data and convert the audio data into a digital audio signal. In addition, the DSP 105 also can be able to perform various kinds of audio processing to the digital audio signal. The various kinds of processing of the DSP 105, however, can be achieved by software with the controller 102. The audio signal or the video signal, after being processed by the DSP 105, is output from the output I/F 106. The output I/F 106 is connected to devices, such as a TV or a speaker. The TV displays a video according to a video signal. The speaker outputs sound according to the audio signal.

The communication I/F 107 is an interface of a wired LAN, for example, and is connected to the wireless router 10 through a LAN cable. The controller 102 receives various types of control information from the smartphone 32 through the communication I/F 107. The controller 102 performs various kinds of operations based on the received control information.

As illustrated in FIG. 4, the STB 30 is provided with a controller 351, a communication I/F 352, a ROM 353, a RAM 354, and an output I/F 355. In other words, the STB 30 has a configuration similar to the configuration of a personal computer. The controller 351 reads out an OS and an application program stored in the ROM 353, to the RAM 354, and performs a variety of operations. The STB 30 receives content data from the Internet, for example, to the communication I/F 352. The STB 30 reproduces the received content data and outputs the reproduced audio signal and video signal from the output I/F 355 to the AV receiver 100.

As illustrated in FIG. 5, the BD player 31 is provided with a controller 371, a play circuit 372, a ROM 373, a RAM 374, and an output I/F 375. The controller 371 reads out firmware stored in the ROM 373 to the RAM 374, and performs a variety of operations. The BD player 31, in the play circuit 372, reads out content data from media (BD), and plays the content data. The BD player 31 outputs an audio signal and a video signal according to the played content data, from the output I/F 375 to the AV receiver 100.

As illustrated in FIG. 6, the automatic performance piano 33 is provided with an output I/F 331, a controller 332, a ROM 333, a RAM 334, a performance circuit 335, and a communication I/F 336. The controller 332 reads out firmware stored in the ROM 333 to the RAM 334, and performs a variety of operations. It is to be noted that the automatic performance piano 33 also functions as an acoustic musical instrument that emits sound as each key of the automatic performance piano 33 is pressed.

The performance circuit 335 uses sequence data on the basis of the MIDI standard, for example, causes a hammer installed corresponding to each key to drive mechanically, and performs an automatic performance. The communication I/F 336 is a wired LAN, for example, and is connected to the wireless router 10. The automatic performance piano 33 receives various types of control information from the smartphone 32 through the communication I/F 336. The controller 332 performs various kinds of operations based on the received control information.

As illustrated in FIG. 7, the smartphone 32 is provided with a touch panel 301, a controller 302, a ROM 303, a RAM 304, a display circuit 305 (display device), and a communication I/F 306. The smartphone 32 is an example of an information processing device.

The touch panel 301 corresponds to a user interface or a receiving circuit that receives an operation from a user. The display circuit 305 presents a variety of information to the user. The touch panel is integrated with the display circuit.

The controller 302 reads out an OS and an application program that are stored in the ROM 303 as a storage medium, to the RAM 304, and performs various kinds of operations. For example, the controller 302, when being directed to start an application program from a user through the touch panel 301, can start the directed application program and can display the screen of the application program on the display circuit 305.

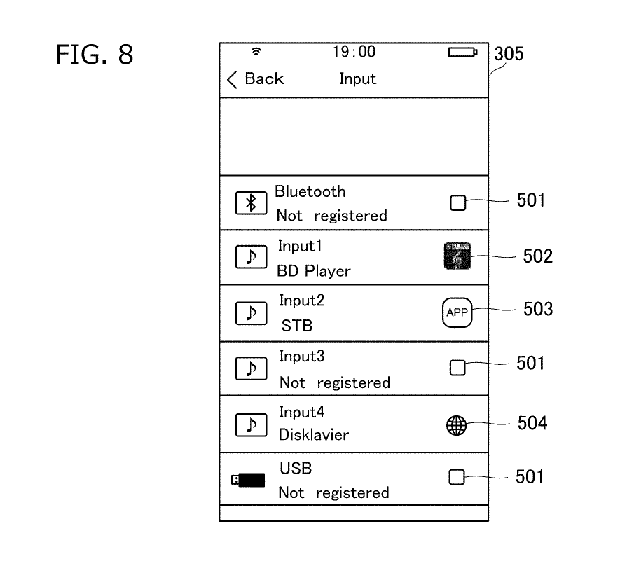

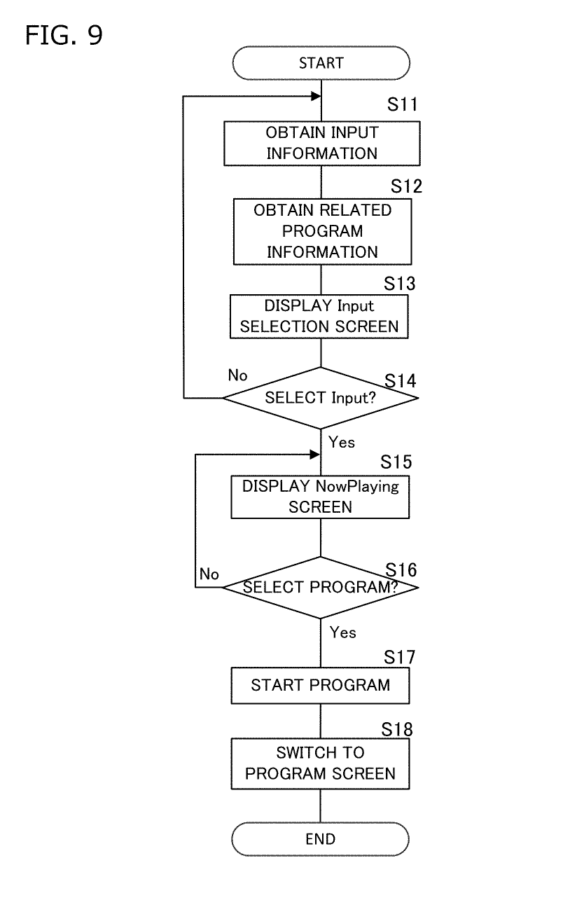

FIG. 8 is a diagram illustrating an example of a setting screen of an application program. FIG. 9 is a flowchart of an operation of the smartphone 32. The screen illustrated in FIG. 8 displays a list of devices that are currently connected to the input I/F 101 of the AV receiver 100 and an icon image of an application program related to each of the devices. The screen can be displayed only in the application program that illustrates a current connection state of the AV receiver 100. In addition, the screen can be displayed by the application program for control, which controls the AV receiver 100. Further, the screen can be displayed by another application program (application program for causing an operation of delivering content from the AV receiver 100 to other devices, for example).

The controller 302 first obtains information (input information) that indicates a current state of the input I/F 101 from the AV receiver 100 (S11). At such a time, the controller 302 functions as an information obtaining circuit 391. In other words, the operation of step S11 corresponds to an operation of the “information obtaining circuit” that obtains input information that indicates the information of one or more devices connected to an input device (AV receiver 100) having an input interface with a plurality of input circuits or inputs.

The information obtaining circuit 391 is executed by a processing circuit, such as a CPU (Central Processing Unit) or a DSP (Digital Signal Processing).

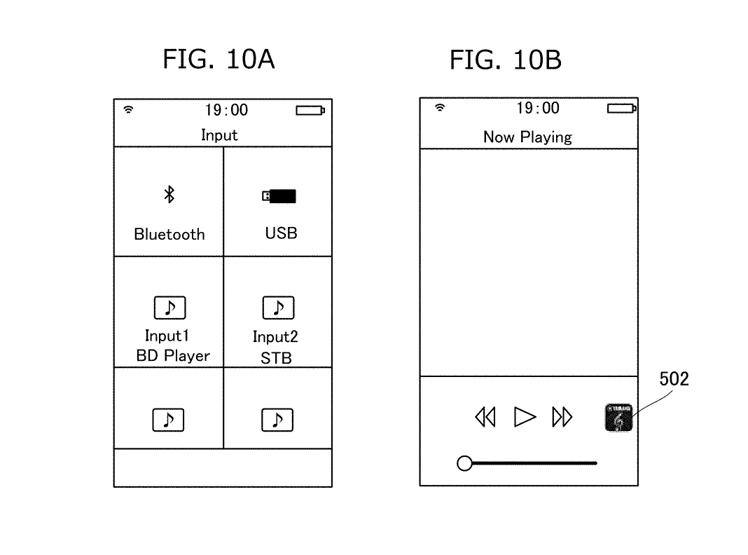

The AV receiver 100 includes an Input 1 connected to the BD player 31, an Input 2 connected to the STB 30, and an Input 4 connected to the automatic performance piano 33. A user, by operating the touch panel 301, inputs a name of the devices with respect to each Input (in the current state of the input I/F 101), an input ID, or the like, to the controller 302. Accordingly, the controller 302 obtains input information that indicates information of the connected devices. As a result, the controller 302, as illustrated in FIG. 10A, is able to display a device name or the like on an Input selection screen.

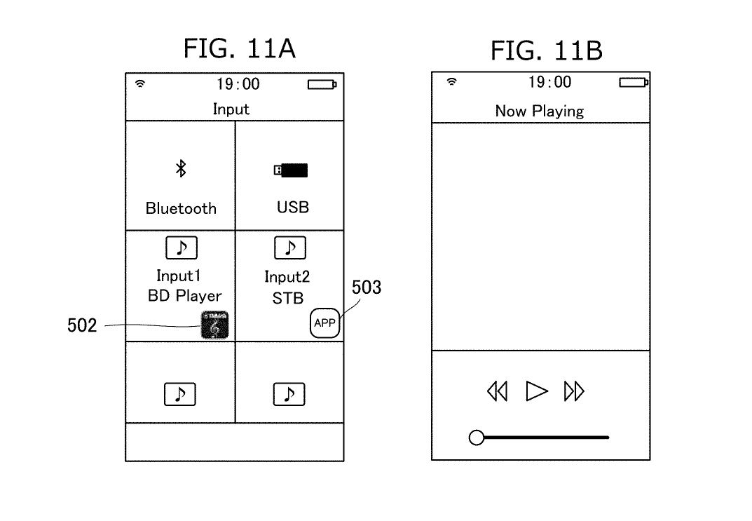

In addition, as illustrated in FIG. 11A, when the Input 1, the Input 2, and the Input 4 correspond to the HDMI (registered trademark) interface, the AV receiver 100 can request the BD player 31, the STB 30, and the automatic performance piano 33 to send the information of each device using the HDMI (registered trademark)-CEC, to the AV receiver 100 itself. In such a case, each of the BD player 31, the STB 30, and the automatic performance piano 33 sends the information of the own device to the AV receiver 100. The information that each device sends includes the name of a device, an address, and identification information (such as a manufacturer ID or a MAC address) or information that indicates a related program (a program name). The address includes a logical address or a physical address in the HDMI (registration information)-CEC. The information is sent from the AV receiver 100 to the smartphone 32. The controller 302, even when performing the above operations, as illustrated in FIG. 10A and FIG. 11A, is able to display a device name and other pieces of information on the Input selection screen.

Subsequently, the controller 302, as illustrated in FIG. 9, obtains information of a program related to each device (S12). But the processing of step S12 need not necessarily be performed at this timing (after the processing of step S11) and can be previously performed at a different timing.

The information of a program related to each device includes information that indicates a directory of a startup file and a symbol image (icon image) of each program. The user can also manually select an application program related to each Input, on the screen illustrated in FIG. 8. For example, when a user selects a blank image 501 on the screen illustrated in FIG. 8, the controller 302 receives selection of a related application program by causing the display circuit 305 to display a list of application programs installed in the own device (a list of symbol images) or the input screen of a directory name for selecting a startup file of an application program.

Alternatively, when the controller 302 receives various types of information from the AV receiver 100, the various types of information includes information (a program name) that indicates a related program of each device. Therefore, the controller 302 searches each directory of the ROM 303 of the own device and extracts a directory name and a startup file name corresponding to the received input name or input ID. Accordingly, the controller 302 obtains the information of a program related to each device.

It is to be noted that the controller 302, in the function of the OS installed in the own device, in the case of being able to obtain the information of an application program installed in the own device (a symbol image and the directory of a startup file), displays a list of all the application programs and receives the selection of an application program from a user. The controller 302, in the function of the OS installed in the own device, in the case of being unable to obtain a list of the application programs installed in the own device, receives an input of a directory in which a startup file of an application program is present, an URL or a program name to start an application program, or the like, from a user.

When an application program is able to obtain a symbol image of other application programs, the controller 302 displays an exclusive symbol image like a symbol image 502 as illustrated in FIG. 8. When an application program is unable to obtain a symbol image of other application programs, the controller 302 displays a general-purpose symbol image like a symbol image 503 as illustrated in FIG. 8.

It is to be noted that the controller 302, when a related program is an application program of a browser, displays a symbol image of a general-purpose browser program like a symbol image 504 illustrated in FIG. 8. When a related program is an application program of a browser, the controller 302 obtains information of a URL (IP address) from a user or a target device. The IP address can be obtained by the HDMI (registered trademark)-CEC. Alternatively, the IP address can be obtained by being searched and detected from the wireless router 10 through the LAN.

Subsequently, as illustrated in FIG. 9, the controller 302 displays an Input selection screen (S13). The Input selection screen, as illustrated in FIG. 10A, for example, displays the name of Input and the name of a device to be connected. Subsequently, the controller 302 determines whether or not an Input selection is received from a user (S14). The controller 302, when receiving the Input selection from a user, can proceed to display processing of a play screen (Now Playing screen) (S15).

FIG. 10B is a diagram of an example of a play screen. The play screen is a screen that displays an album art and the like while a device connected to a selected Input plays audio data, for example. In addition, the play screen is a screen on which a user performs an operation such as change in volume, a stop of play, or the specification of a play position. When a user performs an operation such as change in volume, stop of play, or specification of a play position, the controller 302 sends information according to the operations and information (such as an address or identification information that indicates a target device) to the AV receiver 100. The AV receiver 100, according to the received information, performs change in volume, a stop of play, or specification of a play position, to a corresponding device.

The controller 302, on the play screen, displays a symbol image for switching to a screen of a related program. In the present example, the symbol image 502 is displayed. The controller 302, on the play screen, determines whether or not the symbol image is selected and a related program is thus selected (S16). When a related program is not selected, processing is repeated from step S15 and a play screen is displayed continuously.

The controller 302, when a related program is selected, starts the related program (S17) and switches to the screen of the related program (S18). When the related program is an application program of a browser, the controller 302 can access a specified URL in the application program of the browser. But processing of steps S16 to S18 is not essential. The controller 302 can only display a program related to the device of each Input.

The controller 302 functions as a display processor 392 by thus displaying on the display circuit 305 the switching information (symbol image or character information such as “AV CONTROLLER,” for example) for switching to a program screen related to the device of each Input. Accordingly, the user can easily determine a program to start with respect to a plurality of devices connected to the AV receiver 100 with no need to separately search a program required for each device. In addition, the user can easily start a related program from the list screen or the play screen of Input.

The display processor 392 is executed by the processing circuit, such as a CPU or a DSP. That is, the controller can be or additionally include a CPU and/or DSP.

Subsequently, FIG. 11A illustrates a modification example of the Input selection screen. FIG. 11B illustrates a modification example of the play screen. In the examples, on the Input selection screen, the controller 302 displays a symbol image (the symbol image 502 and the symbol image 503, for example) for switching to a screen of a related program. In addition, in the example, as illustrated in FIG. 11B, the controller 302, on the play screen, does not display the symbol image for switching to the screen of a related program.

Moreover, the controller 302 can display a symbol image of a related program on the Input selection screen and can also display the symbol image of the related program on the play screen.

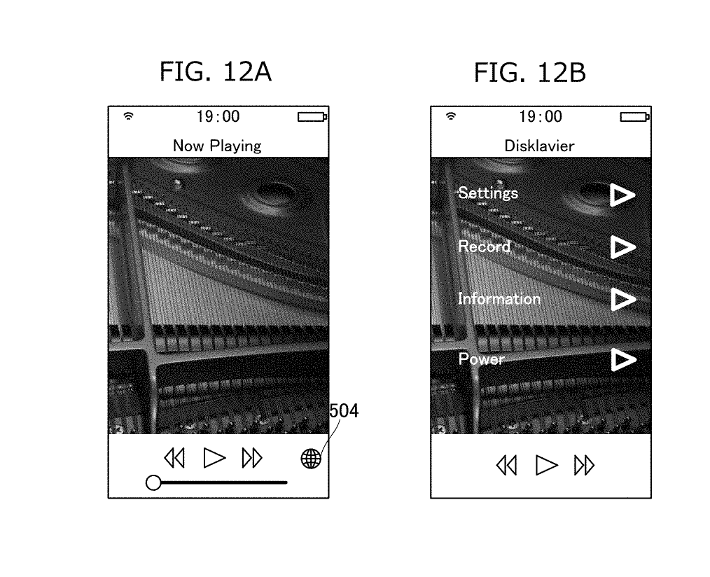

Subsequently, FIG. 12A is a diagram illustrating a play screen on which a symbol image of a related program is displayed. FIG. 12B is a diagram illustrating a screen of the related program that has been started. In the examples, the controller 302 can preferably display a background image on the play screen and a background image of the started related program using a similar image.

Accordingly, even when the controller 302 displays another application program or another page specified by a URL, a user can feel as if another screen of the same application program is displayed.

Each of the controllers mentioned herein can be at least one CPU or at least one dedicated circuit for executing the functions disclosed herein.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing device comprising:
a display device;
at least one memory storing instructions; and
at least one processor configured to implement the stored instructions and execute a plurality of tasks, including:
an information obtaining task that obtains input information; and
a display control task that controls the display device to display switching information for switching to a screen of a program based on the obtained input information.

2. The information processing device according to claim 1, further including:
a user interface configured to receive a user instruction from a user,
wherein the plurality of tasks include:
a selection determination task that determines whether the switching information is selected via the user interface; and
a start program task that, when the selection determination task determines that the switching information is selected, starts the program and causes the display control task to control the display device to display the screen of the program.

3. The information processing device according to claim 2, wherein the program accesses a URL corresponding to the switching information, and causes the display device to display the screen of the program.

4. An information processing device for an input device having an input interface with a plurality of inputs, the information processing device comprising:
a display device;
at least one memory storing instructions; and
at least one processor configured to implement the stored instructions and execute a plurality of tasks, including:
an information obtaining task that obtains input information indicative of each device connected to the input device; and
a display control task that controls the display device to display switching information for switching to a screen of a program associated with each of the plurality of inputs, based on the obtained input information.

5. The information processing device according to claim 4, further including:
a user interface configured to receive a user instruction from a user,
wherein the plurality of tasks include:
a selection determination task that determines whether the switching information is selected via the user interface; and
a start program task that, when the selection determination task determines that the switching information is selected, starts the program and causes the display control task to control the display device to display the screen of the program.

6. The information processing device according to claim 5, wherein the program accesses a URL corresponding to the switching information, and causes the display device to display the screen of the program.

7. The information processing device according to claim 4, wherein the display control task controls the display device to display a background image of a screen on which the switching information is displayed similarly to a background of the screen of the program.

8. The information processing device according to claim 4, wherein the display control task controls the display device to display a selection screen displaying the plurality of inputs, with display information that shows each input on the selection screen and the respective switching information.

9. The information processing device according to claim 4, wherein the display control task controls the display device to display the switching information on a play screen corresponding to a content player connected to each of the plurality of inputs.

10. The information processing device according to claim 4, wherein the information obtaining task receives the input information from the input device.

11. The information processing device according to claim 4, further comprising:
a user interface configured to receive a user instruction from a user,
wherein the display control task controls the display device to display a list screen of the plurality of inputs, and
wherein the plurality of tasks include a selection task that receives a selection of a program associated with each input displayed on the list screen via the user interface.

12. The information processing device according to claim 4, wherein the information processing device is a smartphone including a display device with an integrated touch panel.

13. An information processing method for an information processing device having a display device connected to an input device having an input interface with a plurality of inputs, the method comprising:
an information obtaining step of obtaining input information indicative of each device connected to the input device; and
a display controlling step of controlling the displaying device to display switching information for switching to a screen of a program associated with each of the plurality of inputs, based on the obtained input information.

14. The information processing method according to claim 13, wherein:
the information processing device further includes a user interface configured to receive a user instruction from a user,
the method further comprises:
a selection determination step of determining whether the switching information is selected via the user interface; and
a start program step of, when the selection determination step determines that the switching information is selected, starting the program and cause the display controlling step to control the display device to display the screen of the program.

15. The information processing method according to claim 14, wherein the program accesses a URL corresponding to the switching information.

16. The information processing method according to claim 13, wherein the display controlling step controls the display device so that a background image of a screen on which the switching information is displayed and a background image of the screen of the program are similar.

17. The information processing method according to claim 13, wherein the display controlling step controls the display device to display a selection screen of the plurality of inputs with display information that shows each input on the selection screen and the respective switching information.

18. The information processing method according to claim 13, wherein the display controlling step controls the display device to display the switching information on a play screen corresponding to a content player connected to each of the plurality of inputs.

19. The information processing method according to claim 13, wherein the information obtaining step receives the input information from the input device.

20. The information processing method according to claim 13, wherein:
the information processing device further includes a user interface configured to receive a user instruction from a user,
the display controlling step controls the display device to display a list screen of the plurality of inputs, and
the method further comprises a selecting step of receiving, a selection of a program associated with each input on the list screen via the user interface.
